(19) United States
(12) Patent Application Publication
(10) Pub. No.: US 2020/0361450 A1
(43) Pub. Date: Nov. 19, 2020

(54) VEHICLE CONTROL SYSTEM, VEHICLE CONTROL METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Ryoma Taguchi, Tokyo (JP); Yuta Takada, Tokyo (JP)

(21) Appl. No.: 16/857,238

(22) Filed: Apr. 24, 2020

(30) Foreign Application Priority Data
May 17, 2019 (JP) 2019-093689

(51) Int. Cl. B60W 30/06; B62D 15/02; G08G 1/065; B60W 60/00

(52) U.S. Cl. CPC B60W 30/06; B62D 15/0285; B60W 60/0011; B60W 60/0018; G08G 1/065

(57) ABSTRACT

A vehicle control system includes a recognizer configured to recognize a surrounding situation of a first vehicle and a driving controller configured to cause the first vehicle to stop in a predetermined area of a parking lot by controlling at least one of steering and a speed of the first vehicle on the basis of the situation recognized by the recognizer. When a specific user having priority over another user to get into or out of the first vehicle uses the first vehicle, the driving controller causes the first vehicle to stop at a priority position closer to a pedestrian gate leading to an outside of the parking lot than other positions within the area in preference to a second vehicle different from the first vehicle.

### CROSS-REFERENCE TO RELATED APPLICATION

This application is based upon and claims the benefit of priority from Japanese Patent Application No. 2019-093689, filed May 17, 2019, the entire content of which is incorporated herein by reference.

### BACKGROUND

### Field of the Invention

The present invention relates to a vehicle control system, a vehicle control method, and a storage medium.

### Description of Related Art

In recent years, research has been conducted on automated driving vehicles. Technology for determining the order in which a user uses a parking lot on the basis of a reservation time for the user to use the parking lot and information about the user is also known (see, for example, Japanese Unexamined Patent Application, First Publication No. 2018-49514). A technology is known for preferentially guiding a vehicle equipped with an electronic storage medium pre-storing user information to a dedicated parking space so that a vehicle carrying a disabled person is preferentially parked in the dedicated parking space (see, for example, Japanese Unexamined Patent Application, First Publication No. 2018-73307).

### SUMMARY

A dedicated space where vehicles used by specific users can preferentially park such as a space with an international symbol mark is exclusively provided in a parking lot. In a situation in which the parking lot is congested, there is a case in which a general user desires to stop a vehicle in a dedicated space or a case in which no dedicated space is provided in the parking lot.

Aspects of the present invention provide a vehicle control system, a vehicle control method, and a storage medium capable of giving consideration to the use of a parking lot by a specific user even though no dedicated space is provided.

A vehicle control system, a vehicle control method, and a storage medium according to the present invention adopt the following configurations.

According to aspect (1), a vehicle control system is provided, including: a recognizer configured to recognize a surrounding situation of a first vehicle; and a driving controller configured to cause the first vehicle to stop in a predetermined area of a parking lot by controlling at least one of steering and a speed of the first vehicle on the basis of the situation recognized by the recognizer, wherein, when a specific user having priority over another user to get into or out of the first vehicle uses the first vehicle, the driving controller causes the first vehicle to stop at a priority position closer to a pedestrian gate leading to an outside of the parking lot than other positions within the area in preference to a second vehicle different from the first vehicle.

According to aspect (2), the vehicle control system according to the above-described aspect (1) further includes an inputter configured to receive an input operation of the user, wherein, when a first operation of making a reservation for stopping the first vehicle used by the specific user at the priority position is input to the inputter, the driving controller causes the first vehicle to stop at the priority position in preference to the second vehicle.

According to aspect (3), in the vehicle control system according to the above-described aspect (2), when a second operation of selecting at least one of a plurality of positions leading to the gate as the priority position has been input to the inputter, the driving controller causes the first vehicle to stop at the position selected as the priority position in preference to the second vehicle.

According to aspect (4), the vehicle control system according to the above-described aspect (2) or (3) further includes a management device configured to cause the second vehicle to be restricted from stopping at the priority position on the basis of a scheduled time at which the first vehicle stops at the priority position when the first operation has been input to the inputter.

According to aspect (5), the vehicle control system according to any one of the above-described aspects (2) to (4) further includes a management device configured to cause the second vehicle to be restricted from stopping at the priority position on the basis of a relative positional relationship between the priority position and a position of the first vehicle when the first operation has been input to the inputter.

According to aspect (6), the vehicle control system according to any one of the above-described aspects (2) to (5) further includes a management device configured to limit the number of second vehicles that enter the area including the priority position on the basis of a scheduled time at which the first vehicle stops at the priority position when the first operation has been input to the inputter.

According to aspect (7), the vehicle control system according to any one of the above-described aspects (4) to (6) further includes: a first communication device mounted in the first vehicle and configured to communicate with a second communication device outside the vehicle; and a communication controller configured to transmit first information indicating that a user using the first vehicle is the specific user to the second communication device via the first communication device when the first vehicle enters the area, wherein the management device restricts the second vehicle from being stopped at the priority position in preference to the first vehicle when the first information has been received by the second communication device.

According to aspect (8), the vehicle control system according to any one of the above-described aspects (2) to (7) further includes a management device configured to determine that an incentive is to be provided to a user of the second vehicle that has not stopped at the priority position.

According to aspect (9), in the vehicle control system according to any one of the above-described aspects (1) to (8), the driving controller changes the speed of the first vehicle when the first vehicle is moved to the priority position.

According to aspect (10), in the vehicle control system according to the above-described aspect (9), the driving controller reduces the speed of the first vehicle when the second vehicle is present at the priority position as compared with when the second vehicle is not present at the priority position.

According to aspect (11) of the present invention, a vehicle control method is provided, including: recognizing, by a computer mounted in a first vehicle, a surrounding situation of the first vehicle; causing, by the computer, the first vehicle to stop in a predetermined area of a parking lot by controlling at least one of steering and a speed of the first vehicle on the basis of the recognized situation; and when a specific user having priority over another user to get into or out of the first vehicle uses the first vehicle, causing, by the computer, the first vehicle to stop at a priority position closer to a pedestrian gate leading to an outside of the parking lot than other positions within the area in preference to a second vehicle different from the first vehicle.

According to aspect (12) of the present invention, a computer-readable non-transitory storage medium is provided that stores a program for causing a computer mounted in a first vehicle to: recognize a surrounding situation of the first vehicle; cause the first vehicle to stop in a predetermined area of a parking lot by controlling at least one of steering and a speed of the first vehicle on the basis of the recognized situation; and when a specific user having priority over another user to get into or out of the first vehicle uses the first vehicle, cause the first vehicle to stop at a priority position closer to a pedestrian gate leading to an outside of the parking lot than other positions within the area in preference to a second vehicle different from the first vehicle.

According to any one of aspects (1) to (12), consideration can be given to the use of a parking lot by a specific user even though no dedicated space is provided.

### BRIEF DESCRIPTION OF THE DRAWINGS

FIG. 1 is a configuration diagram of a vehicle system using a vehicle control device according to an embodiment.

FIG. 2 is a functional configuration diagram of a first controller, a second controller, and a third controller.

FIG. 3 is a diagram schematically showing a scene in which an autonomous parking event is executed.

FIG. 4 is a diagram showing an example of a configuration of a parking lot management device.

FIG. 5 is a diagram showing an example of a parking space state table.

FIG. 6 is a diagram showing an example of use schedule information.

FIG. 7 is a diagram showing an example of a website on which the use of a destination facility to be visited can be reserved.

FIG. 8 is a diagram showing an example of a space selection page.

FIG. 9 is a flowchart showing an example of a series of processing steps of an automated driving control device according to the embodiment.

FIG. 10 is a flowchart showing an example of a series of processing steps of the automated driving control device according to the embodiment.

FIG. 11 is a flowchart showing an example of a series of processing steps of a parking lot management device according to the embodiment.

FIG. 12 is a view of a stopping area and a getting-into/out area viewed from above.

FIG. 13 is a diagram showing an example of a scene in which a host vehicle has arrived at a stopping area.

FIG. 14 is a diagram showing another example of a scene in which the host vehicle has arrived at the stopping area.

FIG. 15 is a diagram showing an example of information displayed on an electric bulletin board.

FIG. 16 is a diagram showing another example of a scene in which the host vehicle has arrived at the stopping area.

FIG. 17 is a diagram showing an example of a scene in which the host vehicle has not yet arrived at the stopping area.

FIG. 18 is a diagram showing another example of information displayed on the electric bulletin board.

FIG. 19 is a diagram showing another example of a scene in which the host vehicle has not yet arrived at the stopping area.

FIG. 20 is a diagram showing another example of a scene in which the host vehicle has arrived at the stopping area.

FIG. 21 is a flowchart showing another example of a series of processing steps of the automated driving control device according to the embodiment.

FIG. 22 is a flowchart showing another example of a series of processing steps of the automated driving control device according to the embodiment.

FIG. 23 is a diagram showing an example of a hardware configuration of the automated operation control device according to the embodiment.

### DETAILED DESCRIPTION OF THE INVENTION

Hereinafter, embodiments of a vehicle control system, a vehicle control method, and a storage medium according to the present invention will be described with reference to the drawings.

### [Overall Configuration]

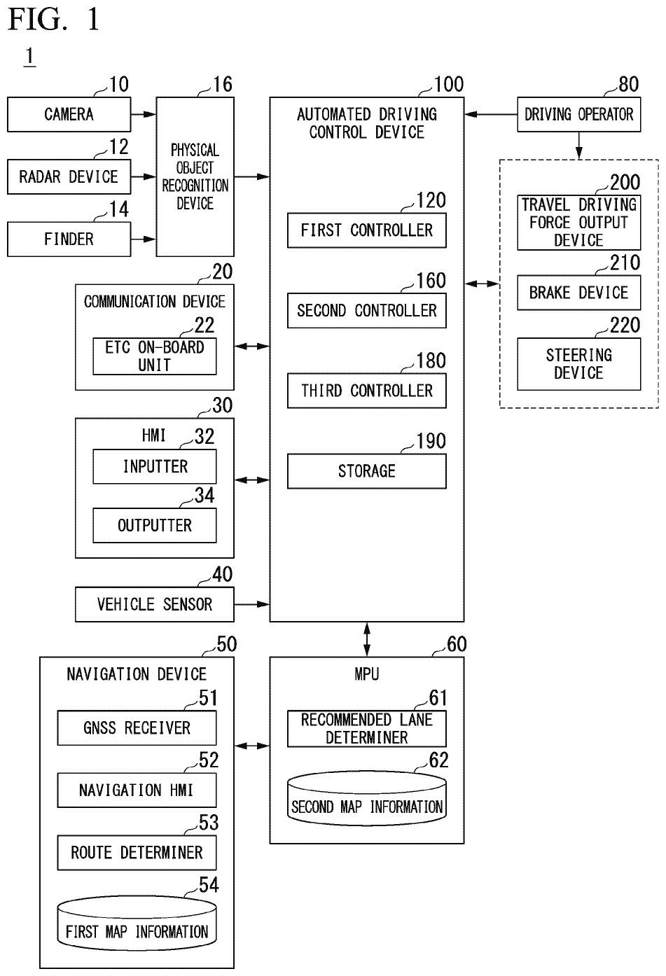

FIG. 1 is a configuration diagram of a vehicle system 1 included in a vehicle control system according to an embodiment. A vehicle equipped with the vehicle system 1 is, for example, a vehicle such as a two-wheeled vehicle, a three-wheeled vehicle, or a four-wheeled vehicle. A driving source of these vehicles is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map-positioning unit (MPU) 60, a driving operator 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and parts of the configuration may be omitted or other configurations may be further added.

For example, the camera 10 is a digital camera using a solid-state imaging element such as a charge-coupled device (CCD) or a complementary metal-oxide semiconductor (CMOS). The camera 10 is attached to any position on the vehicle (hereinafter referred to as a host vehicle M) in which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any position on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of time from light emission to light reception. The radiated light is, for example, pulsed laser light. The finder 14 is attached to any position on the host vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 1.

The communication device 20 communicates with another vehicle present in the vicinity of the host vehicle M, a parking lot management device (to be described below), or various types of server devices using, for example, a cellular network or a Wi-Fi network, Bluetooth (registered trademark), dedicated short range communication (DSRC), or the like. The communication device 20 includes, for example, an electronic toll collection system (ETC) on-board unit 22 and the like. The communication device 20 is an example of a “first communication device”.

The ETC on-board unit 22 transmits information stored in an inserted integrated circuit (IC) card 22A to an external device using DSRC or the like. For example, the IC card 22A stores various types of information required for using the ETC such as an identification number of the host vehicle M, a card identification number, and a date of use of the system. The IC card 22A may store information for identifying that the user using the host vehicle M is a specific user. The specific user is, for example, a user who is predicted to require a long time period to get into and out of the vehicle, a user who requires a larger stopping space than usual when getting into and out of the vehicle, a user for which careful consideration is required when going out, or the like. Specifically, the specific user is an elderly person, a disabled person, an injured person, a sick person, a pregnant woman, or a baby. Hereinafter, such information for identifying a specific user will be described as handicap information. The handicap information is an example of “first information”.

The HMI 30 includes an inputter 32 and an outputter 34. The inputter 32 receives an input operation of the occupant of the host vehicle M. For example, the inputter 32 includes a touch panel, a switch, a key, and the like. The outputter 34 outputs various types of information to the occupant of the host vehicle M. For example, the outputter 34 includes a display, a speaker, and the like. The display of the outputter 34 may be configured integrally with the touch panel of the inputter 32.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect a direction of the host vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by the link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] in a traveling direction of the vehicle), and determines a recommended lane for each block with reference to the second map information 62. The recommended lane determiner 61 determines what number lane the vehicle travels in from the left. The recommended lane determiner 61 determines the recommended lane so that the host vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/postal code), facility information, telephone number information, and the like. The second map information 62 may be updated at any time when the communication device 20 communicates with another device.

For example, the driving operator 80 includes an accelerator pedal, a brake pedal, a shift lever, a steering wheel, a steering wheel variant, a joystick, and other operators. A sensor configured to detect an amount of operation or the presence or absence of an operation is attached to the driving operator 80, and a detection result thereof is output to the automated driving control device 100 or some or all of the travel driving force output device 200, the brake device 210, and the steering device 220.

The automated driving control device 100 includes, for example, a first controller 120, a second controller 160, a third controller 180, and a storage 190. Some or all of the first controller 120, the second controller 160, and the third controller 180 are implemented, for example, by a processor such as a central processing unit (CPU) or a graphics-processing unit (GPU) executing a program (software). Some or all of these components are implemented by hardware (a circuit including circuitry) such as large-scale integration (LSI), an application-specific integrated circuit (ASIC), a field-programmable gate array (FPGA), or a graphics-processing unit (GPU) or may be implemented by software and hardware in cooperation. The program may be pre-stored in a storage device such as an HDD or a flash memory of the storage 190 or may be stored in a removable storage medium such as a DVD or a CD-ROM and installed in the HDD or the flash memory of the storage 190 when the storage medium is mounted in a drive device.

The storage 190 is implemented by, for example, an HDD, a flash memory, an electrically-erasable programmable read-only memory (EEPROM), a read-only memory (ROM), a random-access memory (RAM), or the like. The storage 190 stores, for example, a program or the like read and executed by the processor.

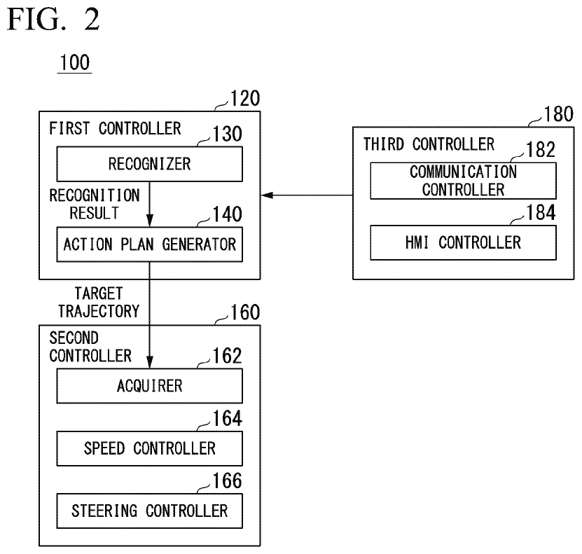

FIG. 2 is a functional configuration diagram of the first controller 120, the second controller 160, and the third controller 180. The first controller 120 includes, for example, a recognizer 130, and an action plan generator 140.

For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured.

The recognizer 130 recognizes a surrounding situation of the host vehicle M on the basis of information input from the camera 10, the radar device 12, and the finder 14 via the physical object recognition device 16, i.e., sensor-fusion detection results. For example, the recognizer 130 recognizes a state such as a position, velocity, or acceleration of a physical object present in the vicinity of the host vehicle M as the surrounding situation. The physical object recognized as the surrounding situation includes, for example, a moving body such as a pedestrian or another vehicle or a stationary body such as a construction tool. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by an area having a spatial extent. The “state” of a physical object may include acceleration or jerk of the physical object or an “action state” (for example, whether or not a lane change is being made or intended).

For example, the recognizer 130 recognizes a lane in which the host vehicle M is traveling (hereinafter referred to as a host vehicle lane), an adjacent lane adjacent to the host vehicle lane, or the like as a surrounding situation. For example, the recognizer 130 recognizes the host vehicle lane or the adjacent lane by comparing a pattern of a road dividing line (for example, an arrangement of solid lines and broken lines) obtained from the second map information 62 with a pattern of road dividing lines in the vicinity of the host vehicle M recognized from an image captured by the camera 10. The recognizer 130 may recognize the host vehicle lane or the adjacent lane by recognizing a traveling path boundary (a road boundary) including a road dividing line, a road shoulder, a curb stone, a median strip, a guardrail, or the like as well as a road dividing line. In this recognition, a position of the host vehicle M acquired from the navigation device 50 or a processing result of the INS may be added. The recognizer 130 may recognize a sidewalk, a stop line (a temporary stop line), an obstacle, red traffic light, a toll gate, a road structure, and other road events.

When the host vehicle lane is recognized, the recognizer 130 recognizes a relative position or orientation of the host vehicle M with respect to the host vehicle lane. For example, the recognizer 130 may recognize a gap of a reference point of the host vehicle M from the center of the lane and an angle formed by a vector indicating a traveling direction of the host vehicle M and a line connected to the center of the lane as a relative position and orientation of the host vehicle M related to the host vehicle lane. Alternatively, the recognizer 130 may recognize a position of the reference point of the host vehicle M related to one side end portion (a road dividing line or a road boundary) of the host vehicle lane or the like as a relative position of the host vehicle M related to the host vehicle lane.

The action plan generator 140 determines an event of automated driving in the route on which the recommended lane has been determined. The event of the automated driving is information that defines the form of behavior to be taken by the host vehicle M during the automated driving, i.e., a traveling aspect. The automated driving means that at least one of the speed and the steering of the host vehicle M is controlled or both thereof are controlled independently of the driving operation of the driver of the host vehicle M. The manual driving means that the steering of the host vehicle M is controlled by the driver of the host vehicle M operating the steering wheel and the speed of the host vehicle M is controlled by the driver operating the accelerator pedal or the brake pedal.

The events may include, for example, a parking event, a constant-speed traveling event, a following traveling event, a lane change event, a branching event, a merging event, an overtaking event, an avoidance event, a takeover event, and the like. The parking event is an event in which the occupant of the host vehicle M causes the host vehicle M to travel autonomously and park in the parking space as in valet parking without parking the host vehicle M in the parking space on his or her own. The constant-speed traveling event is an event for causing the host vehicle M to travel in the same lane at a constant speed. The following traveling event is an event for causing the host vehicle M to follow another vehicle (hereinafter referred to as a preceding vehicle) that is present within a predetermined distance (for example, within 100 [m]) in front of the host vehicle M and is closest to the host vehicle M. “Following” may be, for example, a traveling aspect for causing a relative distance (an inter-vehicle distance) between the host vehicle M and the preceding vehicle to be constantly maintained or a traveling aspect for causing the host vehicle M to travel in the center of the host vehicle lane in addition to causing the relative distance between the host vehicle M and the preceding vehicle to be constantly maintained. The lane change event is an event for causing the host vehicle M to make a lane change from the host vehicle lane to an adjacent lane. The branching event is an event for causing the host vehicle M to move to a lane of a branch road in a target direction at a branch point of a road. The merging event is an event for causing the host vehicle M to move to a lane of a main road at a merging point. The overtaking event is an event for causing the host vehicle M to make a lane change to a previous lane again after the host vehicle M temporarily makes a lane change to an adjacent lane and overtakes a preceding vehicle in the adjacent lane. The avoidance event is an event for causing the host vehicle M to perform at least one of braking and steering in order to avoid an obstacle in front of the host vehicle M. The takeover event is an event for ending automated driving and performing switching to manual driving, and the like.

The action plan generator 140 may change an event already determined for the current section or the next section to another event in accordance with the surrounding situation recognized by the recognizer 130 when the host vehicle M is traveling or determine a new event for the current section or the next section.

The action plan generator 140 generates a future target trajectory along which the host vehicle M is allowed to automatedly travel (independently of a driver's operation) in the traveling aspect defined by the event so that the host vehicle M can generally travel in the recommended lane determined by the recommended lane determiner 61 and further cope with a surrounding situation of the host vehicle M when the host vehicle M travels in the recommended lane. The target trajectory includes, for example, a position element that determines a future position of the host vehicle M and a speed element that determines a future speed and acceleration of the host vehicle M.

For example, the action plan generator 140 determines a plurality of points (trajectory points) at which the host vehicle M is required to sequentially arrive as position elements of the target trajectory. The trajectory point is a point at which the host vehicle M is required to arrive for each predetermined traveling distance (for example, about several meters [m]). The predetermined traveling distance may be calculated, for example, according to a road distance at the time of traveling along the route.

The action plan generator 140 determines a target speed and target acceleration for each predetermined sampling time period (for example, about several tenths of a second [sec]) as speed elements of the target trajectory. The trajectory point may be a position at which the host vehicle M is required to arrive at the sampling time for each predetermined sampling time period. In this case, the target speed or the target acceleration is determined by a sampling time period and an interval between the trajectory points. The action plan generator 140 outputs information indicating the generated target trajectory to the second controller 160.

The second controller 160 controls some or all of the travel driving force output device 200, the brake device 210, and the steering device 220 so that the host vehicle M passes through the target trajectory generated by the action plan generator 140 at a scheduled time. That is, the second controller 160 causes the host vehicle M to be automatedly driven on the basis of the target trajectory generated by the action plan generator 140.

The second controller 160 includes, for example, an acquirer 162, a speed controller 164, and a steering controller 166. A combination of the action plan generator 140 and the second controller 160 is an example of a “driving controller”.

The acquirer 162 acquires information of a target trajectory (trajectory points) generated by the action plan generator 140 and stores the information in the memory of the storage 190.

The speed controller 164 controls one or both of the travel driving force output device 200 and the brake device 210 on the basis of speed elements (for example, a target speed, target acceleration, and the like) included in the target trajectory stored in the memory.

The steering controller 166 controls the steering device 220 in accordance with a position element included in the target trajectory (for example, the curvature representing a degree of curve of a target trajectory or the like) stored in the memory.

For example, processes of the speed controller 164 and the steering controller 166 are implemented by a combination of feed-forward control and feedback control. As one example, the steering controller 166 executes feed-forward control according to the curvature of the road in front of the host vehicle M and feedback control based on a deviation of the host vehicle M from the target trajectory in combination.

The travel driving force output device 200 outputs a travel driving force (torque) for enabling the vehicle to travel to driving wheels. For example, the travel driving force output device 200 may include a combination of an internal combustion engine, an electric motor, a transmission, and the like, and a power electronic control unit (ECU) that controls the internal combustion engine, the electric motor, the transmission, and the like. The power ECU controls the above-described components in accordance with information input from the second controller 160 or information input from the driving operator 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operator 80 so that brake torque according to a braking operation is output to each wheel. The brake device 210 may include a mechanism configured to transfer the hydraulic pressure generated by an operation of the brake pedal included in the driving operator 80 to the cylinder via a master cylinder as a backup. The brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the driving operator 80 to cause the direction of the steerable wheels to be changed.

The third controller 180 includes, for example, a communication controller 182 and an HMI controller 184. The communication controller 182 controls the ETC on-board unit 22 of the communication device 20 such that information stored in the IC card 22A is transmitted to an external device.

The HMI controller 184 controls the outputter 34 of the HMI 30 so that the outputter 34 outputs various types of information.

### [Autonomous Parking Event-when Entering is Performed]

Hereinafter, the function of the action plan generator 140 that has executed the autonomous parking event will be described. The action plan generator 140 that has executed the autonomous parking event causes the host vehicle M to park in a parking space within a parking lot PA, for example, on the basis of information acquired from the parking lot management device 400 by the communication device 20.

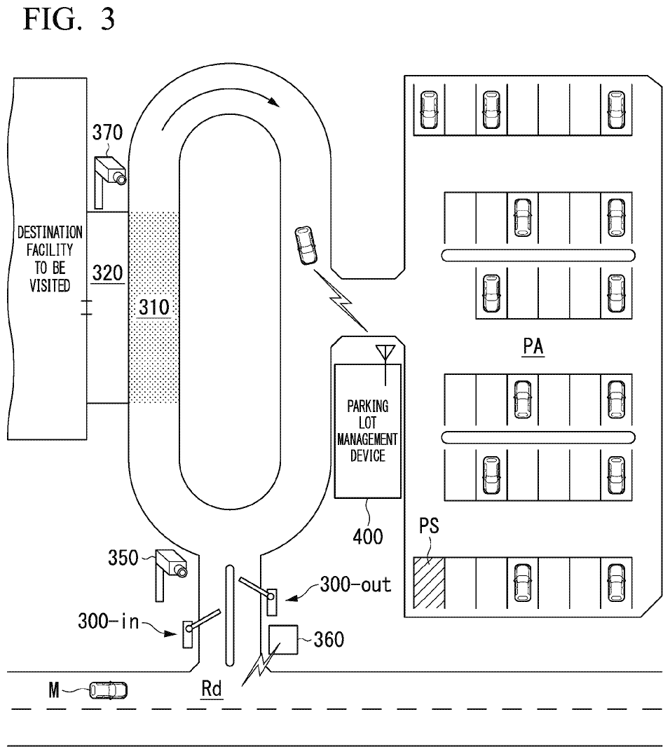

FIG. 3 is a diagram schematically showing a scene in which the autonomous parking event is executed. An entrance gate 300-in, an exit gate 300-out, an entrance-monitoring camera 350, an ETC communication device 360, and a getting-into/out-monitoring camera 370 are provided on a route from a road Rd to the destination facility to be visited. The destination facilities to be visited include, for example, shopping stores, restaurants, accommodation facilities such as hotels, airports, hospitals, and event venues, and the like. These devices and equipment are included in the vehicle control system according to the embodiment.

The entrance gate 300-in and the exit gate 300-out are opened and closed in accordance with instructions of the parking lot management device 400.

The entrance-monitoring camera 350 captures an image of a vehicle passing through the entrance gate 300-in. The entrance-monitoring camera 350 transmits the captured still image or moving image to the parking lot management device 400.

The ETC communication device 360 is installed near the entrance gate 300-in, wirelessly communicates with the IC card 22A via the ETC on-board unit 22 mounted in a vehicle approaching the entrance gate 300-in, and acquires various types of information from the IC card 22A. The ETC communication device 360 transmits information acquired from the IC card 22A to the parking lot management device 400. The ETC communication device 360 is an example of a “second communication device”.

The getting-into/out-monitoring camera 370 captures images of the stopping area 310 and the getting-into/out area 320. The getting-into/out-monitoring camera 370 transmits the captured still images or moving images to the parking lot management device 400.

The stopping area 310 faces the getting-into/out area 320 connected to the destination facility to be visited and is an area where the vehicle is allowed to temporarily stop so that an occupant may get out of the vehicle in the getting-into/out area 320 or get into the vehicle in the getting-into/out area 320. The getting-into/out area 320 is an area provided for an occupant who gets out of the vehicle, an occupant who gets into the vehicle, or an occupant who waits at a place until the vehicle arrives. The getting-into/out area 320 is typically provided on one side of the road on which the stopping area 310 is provided. Eaves for avoiding rain, snow, and sunlight may be provided in the getting-into/out area 320. The stopping area 310 and the getting-into/out area 320 are examples of a “predetermined area”.

For example, the host vehicle M travels to the stopping area 310 through the entrance gate 300-in according to manual driving or automated driving.

The host vehicle M that has traveled to the stopping area 310 stops at the stopping area 310 and allows the occupant to get out of the host vehicle M in the getting-into/out area 320. Subsequently, the host vehicle M performs unmanned automated driving and starts the autonomous parking event in which the host vehicle M autonomously moves from the stopping area 310 to the parking space PS within the parking lot PA. A start trigger of the autonomous parking event may be, for example, a situation in which the host vehicle M has approached to within a predetermined distance of the destination facility to be visited, a situation in which the occupant has activated a dedicated application in a terminal device such as a portable phone, or a situation in which the communication device 20 has wirelessly received a predetermined signal from the parking lot management device 400.

When the autonomous parking event starts, the action plan generator 140 controls the communication device 20 so that the communication device 20 transmits a parking request to the parking lot management device 400. When there is a space where the vehicle can be parked in the parking lot PA, the parking lot management device 400 that has received the parking request transmits a predetermined signal as a response to the parking request to the vehicle of a transmission source of the parking request. The host vehicle M that has received the predetermined signal moves from the stopping area 310 to the parking lot PA in accordance with guidance of the parking lot management device 400 or while performing sensing on its own. Also, when the autonomous parking event is performed, the host vehicle M does not necessarily have to be unmanned and a staff member of the parking lot PA may get into the host vehicle M.

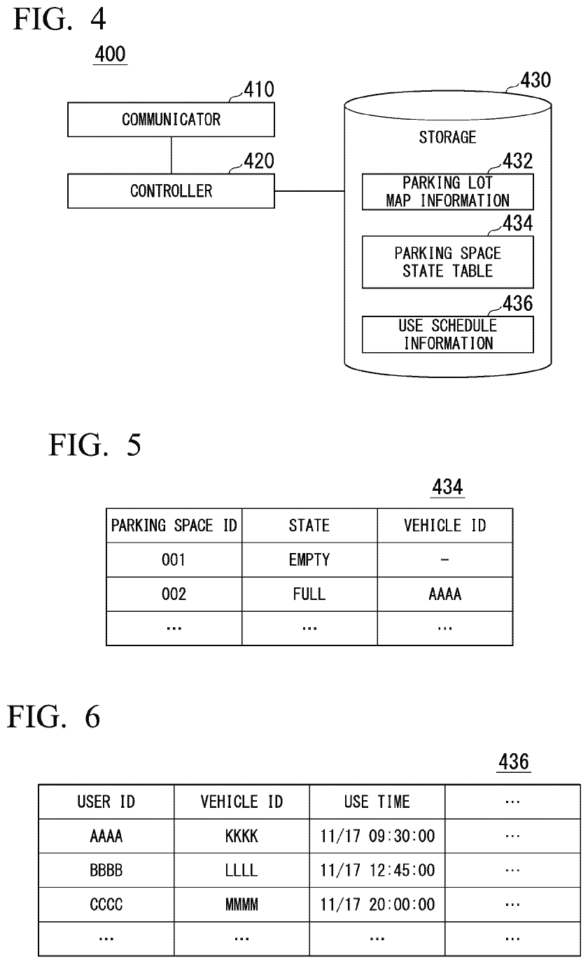

FIG. 4 is a diagram showing an example of a configuration of the parking lot management device 400. The parking lot management device 400 includes, for example, a communicator 410, a controller 420, and a storage 430.

The communicator 410 wirelessly communicates with the host vehicle M and other vehicles and wirelessly communicates with the entrance gate 300-in, the exit gate 300-out, the entrance-monitoring camera 350, the ETC communication device 360, and the getting-into/out-monitoring camera 370.

The controller 420 is implemented by, for example, a processor such as a CPU or a GPU executing a program (software). The controller 420 may be implemented by hardware (a circuit including circuitry) such as LSI, an ASIC, and an FPGA or may be implemented by software and hardware in cooperation. The program may be pre-stored in an HDD, a flash memory, or the like of the storage 430 or may be stored in a removable storage medium such as a DVD or a CD-ROM and installed in the storage 430 when the storage medium is mounted in a drive device.

The storage 430 is implemented by, for example, an HDD, a flash memory, an EEPROM, a ROM, a RAM, or the like. The storage 190 stores, for example, information such as parking lot map information 432, a parking space state table 434, and use schedule information 436 in addition to programs to be read and executed by the processor.

The parking lot map information 432 is information that geometrically represents the structure of the parking lot PA, and includes, for example, coordinates for each parking space PS.

FIG. 5 is a diagram showing an example of the parking space state table 434. As in the example shown in FIG. 5, the parking space state table 434 has information in which a state that is an empty state in which no vehicle is parked in the parking space indicated by the parking space ID or is a full (parked) state in which a vehicle is parked in the parking space indicated by the parking space ID and a vehicle ID that is identification information of a parked vehicle in the case of the full state are associated with the parking space ID that is identification information of the parking space PS.

FIG. 6 is a diagram showing an example of use schedule information 436. As shown in the example in FIG. 6, the use schedule information 436 is information in which an ID of a vehicle used by a user indicated by a user ID, a use time of the stopping area 310 where the vehicle is required to be temporarily stopped when the destination facility to be visited is used, or the like is associated with the user ID for identifying a specific user or a person related to the specific user (for example, a family accompanying the specific user or the like). For example, the specific user or the person related to the specific user accesses a website on which a reservation can be made to use a destination facility to be visited using a terminal device such as an HMI 30, a portable phone, a personal computer, or a dedicated terminal installed in the destination facility to be visited. The HMI 30 is an example of an “inputter” and a terminal device such as a portable phone or a personal computer is another example of the “inputter”.

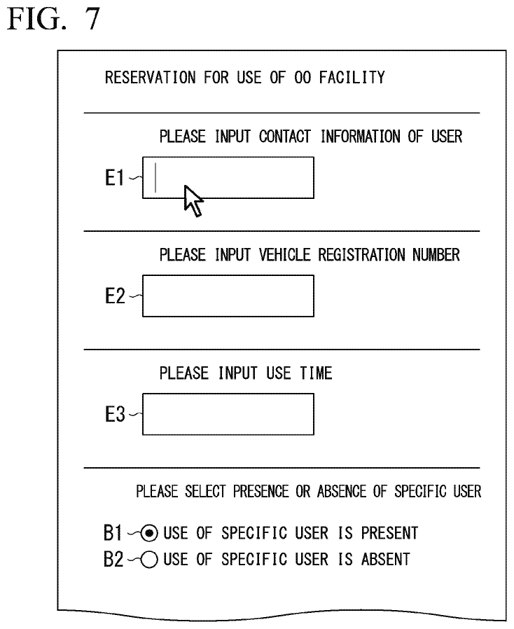

FIG. 7 is a diagram showing an example of a website on which the use of a destination facility to be visited can be reserved. As shown in FIG. 7, an input field E1 to which a user's contact information can be input, an input field E2 to which a vehicle registration number can be input, an input field E3 to which a use time of a destination facility to be visited can be input, buttons B1 and B2 for selecting whether or not a specific user is included in users using the destination facility to be visited, and the like are displayed on the website. For example, on a website accessed by the specific user or the person related to the specific user, personal information such as an e-mail address and a telephone number is input to the input field E1, a vehicle registration number is input to the input field E2, and a use time of a destination facility to be visited is input to the input field E3, and the button B1 or B2 is selected in accordance with the presence or absence of the use of the facility by the specific user. When the button B1 has been selected, the screen of the terminal device operated by the user transitions to a space selection page for causing the vehicle to stop.

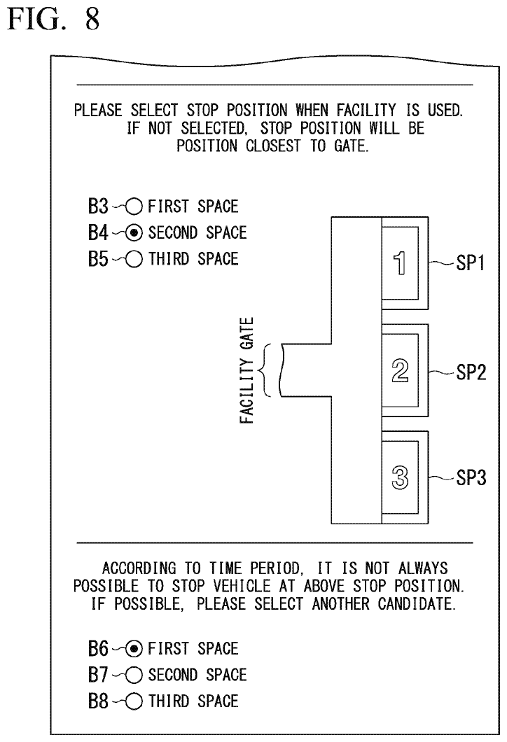

FIG. 8 is a diagram showing an example of the space selection page. As shown in FIG. 8, a user is allowed to select a space of the stopping area 310 where a vehicle carrying a specific user is stopped when the specific user visits a facility on the selection page. For example, when three spaces are explicitly defined by parking slots of white lines and the like in the stopping area 310, a button B3 for selecting a foremost first space SP1 among the three spaces as the stop position, a button B4 for selecting a middle second space SP2 as the stop position, and a button B5 for selecting a last third space SP3 as the stop position are displayed on the selection page. Among these three spaces, the second space SP2 is closest to the gate of the facility and is highly convenient. Thus, when the user has not selected any button, the second space SP2 is automatedly selected at the stop position. In the example shown in FIG. 8, the button B4 is selected. An operation on buttons B4 to B6 is an example of a “first operation”.

A vehicle may not stop in a space selected as the stop position by a user. For example, it is assumed that another vehicle stops in the second space SP2 at a time before the time of use reserved by a user and another user gets out of or into the other vehicle. In this case, it takes time for the user to get into or out of the vehicle and a situation in which the second space SP2 is occupied by the other vehicle even at the reservation time may occur.

In consideration of such circumstances, buttons B6 to B8 for selecting the next candidate for the stop position are further displayed on the selection page. In the example shown in FIG. 8, the second space SP2 is selected as a space where a vehicle is stopped with the top priority and the first space SP1 is selected as a space where a vehicle is stopped with the second priority. The operation on the buttons B6 to B8 is an example of a “second operation”.

The controller 420 acquires these pieces of registration information from a web server that provides the website and stores the acquired information in the storage 430 as use schedule information 436. These pieces of information may be registered via an application that provides a service equivalent to that of the website.

The controller 420 guides the vehicle to the parking space PS on the basis of information acquired (received) by the communicator 410 and information stored in the storage 430. When the communicator 410 receives a parking request from the vehicle, the controller 420 extracts a parking space PS in an empty state with reference to the parking space state table 434 and acquires a position of the extracted parking space PS from the parking lot map information 432. The controller 420 transmits acquired route information indicating a suitable route to the parking space PS to the vehicle using the communicator 410. The controller 420 may instruct a specific vehicle to stop or slow down, as necessary, on the basis of a positional relationship between a plurality of vehicles so that the vehicles do not move to the same position at the same time.

When the host vehicle M receives the route information from the parking lot management device 400, the action plan generator 140 generates a target trajectory based on the route. For example, the action plan generator 140 sets the target speed to a speed lower than a speed limit within the parking lot PA on a route from a current position of the host vehicle M to the parking space PS and generates a target trajectory in which trajectory points are arranged in the center of a road within the parking lot PA. When the host vehicle M approaches a target parking space PS, the recognizer 130 recognizes parking slot lines or the like that partition the parking space PS and recognizes a relative position of the parking space PS with respect to the host vehicle M. When the parking space PS is recognized, the recognizer 130 provides the action plan generator 140 with recognition results such as a direction of the recognized parking space PS (a direction of the parking space viewed from the host vehicle M) and a distance to the parking space PS. The action plan generator 140 corrects the target trajectory on the basis of the provided recognition result. The second controller 160 controls the steering and the speed of the host vehicle M in accordance with the target trajectory corrected by the action plan generator 140 so that the host vehicle M parks in the parking space PS.

### [Autonomous Parking Event-when Leaving is Performed]

The action plan generator 140 and the communication device 20 maintain the operating state even if the host vehicle M is parked. For example, it may be assumed that, after the occupant who has got out of the host vehicle M stopped in the stopping area 310 in the getting-into/out area 320 completes things to be done in the destination facility to be visited, a dedicated application is activated by operating a terminal device and a pick-up request is transmitted to the parking lot management device 400. The pick-up request is a command for paging the host vehicle M from a remote place distant from the host vehicle M and requesting the host vehicle M to move to a position close to the occupant.

The parking lot management device 400 monitors the number of vehicles entering the stopping area 310 and transmits the pick-up request to the communication device 20 of the host vehicle M while performing arbitration so that vehicles do not overflow from the stopping area 310.

When the pick-up request is received by the communication device 20, the action plan generator 140 executes an autonomous parking event. The action plan generator 140 that has executed the autonomous parking event generates a target trajectory for causing the host vehicle M to move from the parking space PS where the host vehicle M is parked to the stopping area 310. The second controller 160 causes the host vehicle M to move to the stopping area 310 in accordance with the target trajectory generated by the action plan generator 140. For example, the action plan generator 140 may set a speed lower than the speed limit within the parking lot PA as the target speed on the route to the stopping area 310 and generate a target trajectory in which the trajectory points are arranged in the center of the road within the parking lot PA.

When the host vehicle M approaches the stopping area 310, the recognizer 130 recognizes the getting-into/out area 320 facing the stopping area 310 and recognizes a physical object such as a person or luggage present within the getting-into/out area 320. Further, the recognizer 130 recognizes the occupant of the host vehicle M from one or more persons present within the getting-into/out area 320. For example, when there are a plurality of persons within the getting-into/out area 320 and there are a plurality of occupant candidates, the recognizer 130 may distinguish and recognize an occupant of the host vehicle M and other occupants on the basis of a radio wave intensity of a terminal device possessed by the occupant of the host vehicle M and a radio wave intensity of an electronic key capable of locking or unlocking the host vehicle M. For example, the recognizer 130 may recognize a person having a highest radio wave intensity as the occupant of the host vehicle M. The recognizer 130 may distinguish and recognize the occupant of the host vehicle M and other occupants on the basis of a feature quantity of a face of each occupant candidate and the like. When the host vehicle M approaches the occupant of the host vehicle M, the action plan generator 140 corrects the target trajectory by further reducing the target speed or moving the trajectory points from the center of the road to a position close to the getting-into/out area 320. In response to this, the second controller 160 causes the host vehicle M to stop at a position close to the getting-into/out area 320 side within the stopping area 310.

The action plan generator 140 controls the communication device 20 so that the communication device 20 transmits a departure request to the parking lot management device 400 when a target trajectory is generated in response to a pick-up request. When the departure request is received by the communicator 410, the controller 420 of the parking lot management device 400 instructs a specific vehicle to stop or slow down, as necessary, on the basis of a positional relationship between a plurality of vehicles so that the vehicles do not move to the same position at the same time as in the entering process. When the host vehicle M moves to the stopping area 310 and the occupant present in the getting-into/out area 320 gets into the host vehicle M, the action plan generator 140 causes the autonomous parking event to end. Subsequently, the automated driving control device 100 plans a merging event or the like in which the host vehicle M is allowed to move from the parking lot PA to a road in the city area and automated driving is performed, or the occupant manually drives the host vehicle M on his or her own, on the basis of the planned event.

The action plan generator 140 may find an empty parking space PS on its own on the basis of a detection result of the camera 10, the radar device 12, the finder 14, or the physical object recognition device 16 independently of communication and cause the host vehicle M to be parked within the found parking space PS without being limited to the above description.

### [Process Flow of Automated Driving Control Device at the Time of Entering]

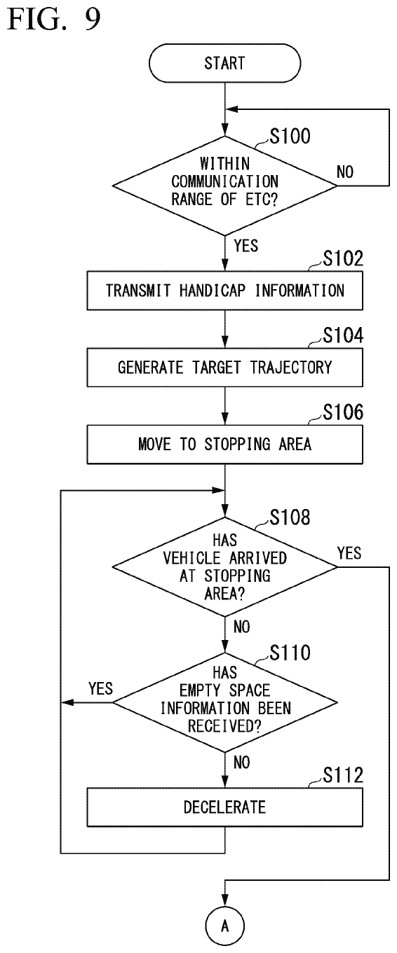

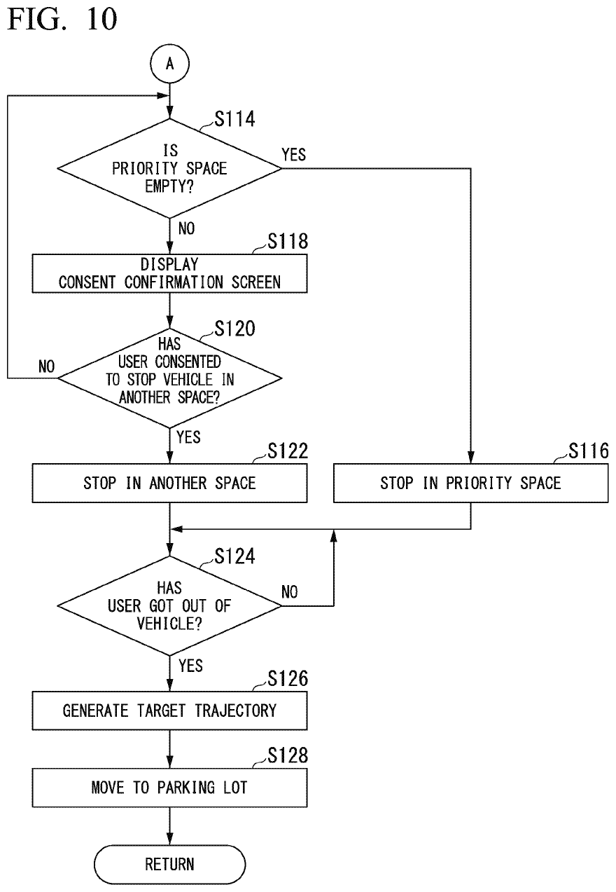

Hereinafter, a series of processing steps of the automated driving control device 100 at the time of entering will be described with reference to flowcharts. FIGS. 9 and 10 are flowcharts showing an example of a series of processing steps of the automated driving control device 100 according to the embodiment. The process of the present flowchart is iteratively performed at predetermined time intervals when a specific user is in the host vehicle M. While the process of the present flowchart is performed, the recognizer 130 is assumed to continuously perform various types of recognition unless otherwise specified.

First, the communication controller 182 waits until the host vehicle M is included within a communication range of the ETC communication device 360 (step S100) and controls the ETC on-board unit 22 so that the ETC on-board unit 22 transmits handicap information to the ETC communication device 360 together with identification information of the host vehicle M when the host vehicle M is included within the communication range of the ETC communication device 360 (step S102).

Next, the action plan generator 140 determines an autonomous parking event as an event of a route leading to the stopping area 310 and starts the autonomous parking event. The action plan generator 140 generates a target trajectory for causing the host vehicle M to move from the entrance gate 300-in to the stopping area 310 (step S104).

Next, the second controller 160 performs automated driving on the basis of the target trajectory generated by the action plan generator 140 and causes the host vehicle M to move to the stopping area 310 (step S106).

Next, the action plan generator 140 determines whether or not the host vehicle M has arrived at the stopping area 310 with reference to the recognition result of the recognizer 130 (step S108).

When it is determined that the host vehicle M has not yet arrived at the stopping area 310, the action plan generator 140 determines whether or not the communication device 20 has received information indicating that another vehicle has not yet parked in a priority space (hereinafter referred to as empty space information) among a plurality of spaces in which the vehicle can be stopped in the stopping area 310 (step S110).

The priority space is a space where a vehicle used by a specific user compared to a vehicle used by a user other than the specific user (for example, a user without a handicap) can be preferentially stopped or a space in which a vehicle scheduled to be used by a specific user compared to a vehicle scheduled to be used by a user other than the specific user can be preferentially stopped.

The space selected as the stop position of the host vehicle M by operating the various types of buttons on the website described above becomes the priority space. When the stop position of the host vehicle M has not been selected on the website, a space relatively closer to the facility than other spaces among a plurality of spaces included in the stopping area 310 is determined to be the priority space. In other words, a space where it is relatively highly convenient to access the facility as compared with other spaces among the plurality of spaces included in the stopping area 310 is determined to be the priority space. The space where it is highly convenient to access the facility is, for example, a space near a pedestrian gate leading to the facility. The gate may be a simple passage, an escalator or an elevator. The space where it is highly convenient to access the facility may be, for example, a relatively large space as compared with other spaces.

For example, the parking lot management device 400 determines whether or not the vehicle is stopped in the priority space by analyzing the image of the getting-into/out-monitoring camera 370 and transmits the empty space information to the host vehicle M into which the specific user has got if no vehicle is stopped in the priority space.

When the empty space information has been received by the communication device 20 but the host vehicle M has not yet arrived at the stopping area 310, the action plan generator 140 maintains a current vehicle speed without changing the speed or the acceleration that is the speed element of the target trajectory.

When the empty space information has not been received by the communication device 20 and the host vehicle M has not yet arrived at the stopping area 310, the action plan generator 140 reduces the speed or the acceleration that is the speed element of the target trajectory in accordance with a state in which the host vehicle M approaches the stopping area 310 so that the host vehicle M is gradually decelerated (step S112). Thereby, when the host vehicle M moves to the stopping area 310 in a state in which it is not determined whether or not the priority space is empty, the host vehicle M can be allowed to sufficiently decelerate. Thereby, even if the priority space is occupied by another vehicle, the host vehicle M may be able to be smoothly stopped in the priority space within the stopping area 310 because the probability that the other vehicle will have moved from the priority space when the host vehicle M arrives at the stopping area 310 is high.

When it is determined that the host vehicle M has arrived at the stopping area 310, the action plan generator 140 determines whether or not the priority space within the stopping area 310 is empty on the basis of a recognition result of the recognizer 130 (step S114).

When no other vehicle is stopped in the priority space and the priority space is empty, the action plan generator 140 generates a target trajectory for causing the host vehicle M to move to the priority space and stop in the priority space. In response to this, the second controller 160 causes the host vehicle M to stop in the priority space by controlling the speed and steering of the host vehicle M on the basis of the target trajectory (step S116).

When another vehicle is already stopped in the priority space and the priority space is not empty, the HMI controller 184 causes the display of the outputter 34 to display a consent confirmation screen (step S118). The consent confirmation screen is a screen for asking for the consent of the user so that the host vehicle M is parked in another space (for example, a space before or after the priority space) when the priority space is not empty.

After the consent confirmation screen is displayed on the display, the action plan generator 140 determines whether or not the user has input an operation in which the user consents to stop the host vehicle M in another space (hereinafter referred to as a consent operation) to the inputter 32 (step S120), returns the process to S114 when the consent operation has not been input to the inputter 32, and causes the host vehicle M to wait at a place until the priority space becomes empty. Specifically, the action plan generator 140 causes the host vehicle M to stop at a place by setting the speed or acceleration, which is the speed element of the target trajectory, to zero.

When the buttons B6 to B8 have been operated on the space selection page shown in the example of FIG. 8, i.e., when the user consents to set another space as the stop position in preparation for a case in which the priority space is not already empty, the processing of S118 and S120 may be omitted.

When the consent operation has been input to the inputter 32, the action plan generator 140 generates a target trajectory for causing the host vehicle M to move to another space and stop in the other space. In response to this, the second controller 160 causes the host vehicle M to stop in the other space by controlling the speed and steering of the host vehicle M on the basis of the target trajectory (step S122).

Next, the action plan generator 140 determines whether or not a specific user has got out of the host vehicle M (step S124). For example, the action plan generator 140 may determine whether or not the specific user has got out of the host vehicle M on the basis of a detection result of a door sensor that detects opening and closing of a door of the host vehicle M and an image of a camera installed in the interior of the host vehicle M.

When the specific user has got out of the host vehicle M, the action plan generator 140 generates a target trajectory from the stopping area 310 to the parking lot PA (step S126). In response to this, the second controller 160 causes the host vehicle M to move to the parking lot PA in accordance with the target trajectory and causes the host vehicle M to be parked in the parking space PS of the parking lot PA (step S128). Thereby, the process of the present flowchart ends.

### [Process Flow of Parking Lot Management Device]

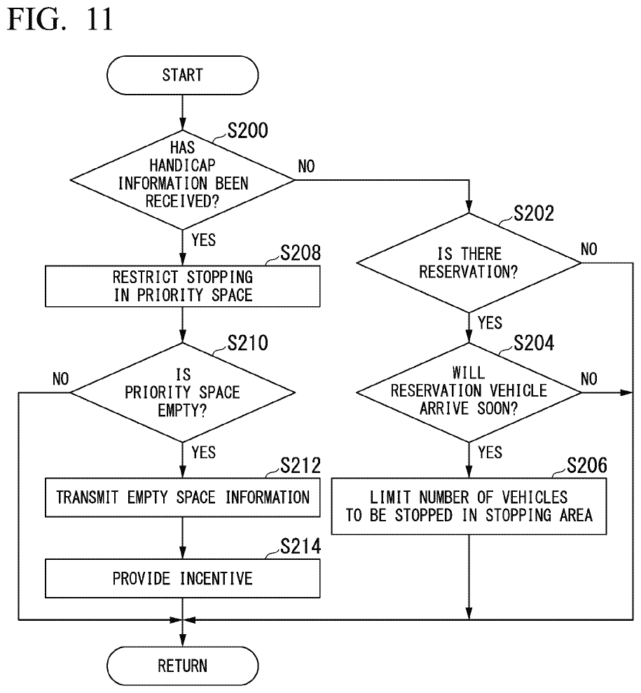

Hereinafter, a series of processing steps of the parking lot management device 400 will be described with reference to a flowchart. FIG. 11 is a flowchart showing an example of the series of processing steps of the parking lot management device 400 according to the embodiment. The process of the present flowchart is iteratively performed at predetermined time intervals.

First, the controller 420 determines whether or not the communicator 410 has received handicap information (step S200).

When the communicator 410 has not received the handicap information, i.e., when a vehicle carrying a specific user has not passed through the entrance gate 300-in, the controller 420 determines whether or not a reservation has been made for the specific user who uses the destination facility to be visited in a time period from a current time to a predetermined time (for example, 15 minutes) with reference to the use schedule information 436 (step S202).

When a reservation has been made for the specific user who uses the destination facility to be visited, the controller 420 determines whether or not the vehicle carrying the specific user who has reserved the use of the facility (hereinafter referred to as a reservation vehicle) will arrive at the entrance gate 300-in within a predetermined time period (for example, 10 minutes) (step S204).

For example, the controller 420 performs wireless communication with the reservation vehicle via the communicator 410, acquires position information of the reservation vehicle, and calculates a time period by dividing a relative distance (a relative distance taken along the road) between a position of the reservation vehicle and the entrance gate 300-in by the speed of the reservation vehicle. The controller 420 determines that the reservation vehicle will arrive at the entrance gate 300-in within the predetermined time period when the calculated time period is less than or equal to a predetermined time period and determines that the reservation vehicle will not arrive at the entrance gate 300-in within the predetermined time period when the calculated time period exceeds the predetermined time period.

When it is determined that the reservation vehicle will arrive at the entrance gate 300-in within the predetermined time period, the controller 420 limits the number of vehicles to be moved from the parking lot PA to the stopping area 310 according to automated driving among a plurality of vehicles parked in the parking lot PA in a time period including a reservation time at which the specific user uses the destination facility to be visited (step S206).

Because the stopping area 310 is a finite area, the number of vehicles that can stop at one time in the stopping area 310 is limited. For example, when the stopping area 310 includes a total of three spaces of the first space SP1, the second space SP2, and the third space SP3, the maximum number of vehicles that can move from the parking lot PA to the stopping area 310 is three. However, when a reservation vehicle carrying a specific user passes through the entrance gate 300-in and goes to the stopping area 310, a situation in which at least one vehicle among the total of four vehicles going to the stopping area 310 cannot stop in the stopping area 310 and must stop on a road on the way may occur if three vehicles have been allowed to go from the parking lot PA to the stopping area 310.

Accordingly, when a pick-up request has been received from a user of each vehicle parked in the parking lot PA, the controller 420 determines whether or not the number of vehicles allowed to go to the stopping area 310 is equal to or greater than the maximum number of vehicles n that can be stopped in the stopping area 310 at one time. When the number of vehicles allowed to go to the stopping area 310 in response to the pick-up request is equal to or greater than the maximum number of vehicles n, the controller 420 causes at least n−1 vehicles to go from the parking lot PA to the stopping area 310. Here, the number of n−1 vehicles is 1 smaller than the maximum number of vehicles n. At this time, the controller 420 instructs each of the n−1 vehicles (or fewer vehicles) going to the stopping area 310 to stop in a space other than the priority space. Thereby, even if the reservation vehicle that has passed through the entrance gate 300-in enters the stopping area 310, the reservation vehicle can quickly stop in the priority space of the stopping area 310 without waiting.

When it is determined that the communicator 410 has received the handicap information, i.e., when a vehicle carrying a specific user has passed through the entrance gate 300-in, in the processing of S200, the controller 420 performs control for restricting stopping in the priority space with respect to the vehicles that are going to the stopping area 310 (step S208).

If the vehicle that has passed through the entrance gate 300-in is not a reservation vehicle for which an advance reservation has been made, a number of vehicles equal to the maximum number of vehicles n have been allowed to go from the parking lot PA to the stopping area 310 or an instruction for preventing a vehicle allowed to go to the stopping area 310 from being stopping in the priority space may not be issued. Thus, when a vehicle carrying a specific user has passed through the entrance gate 300-in, the controller 420 performs control for prompting a user of a vehicle already going to the stopping area 310 (or a vehicle which is highly likely to go thereto) to give up the priority space. Details of the specific processing of S208 will be described below using a scene diagram.

Next, the controller 420 determines whether or not a vehicle has stopped in the priority space by analyzing an image of the getting-into/out-monitoring camera 370 (step S210). When the vehicle that has transmitted the handicap information when passing through the entrance gate 300-in is not a reservation vehicle, no priority space is selected in advance and thus the priority space is determined to be a space closest to the gate of the facility.

Next, when it is determined that the vehicle has not stopped in the priority space, the controller 420 transmits empty space information to the vehicle that has transmitted the handicap information when passing through the entrance gate 300-in via the communicator 410 (step S212).

Next, the controller 420 determines that an incentive (a reward) is to be provided to a user of another vehicle going to the stopping area 310 because the other vehicle has not stopped in the priority space when the vehicle that has transmitted the handicap information has passed the entrance gate 300-in (step S212). Thereby, the process of the present flowchart ends.

For example, the incentive is points available for payment of a usage fee of the parking lot PA. The points provided as the incentive may be used for payment of a usage fee of another service (for example, a purchase price for shopping or the like) other than the payment of the usage fee of the parking lot PA. The incentive may be a coupon, a ticket, a discount ticket, or the like having an effect similar to that of points, the right to stop the host vehicle M with priority over other vehicles in the stopping area 310, or the like.

### [Scene Description]

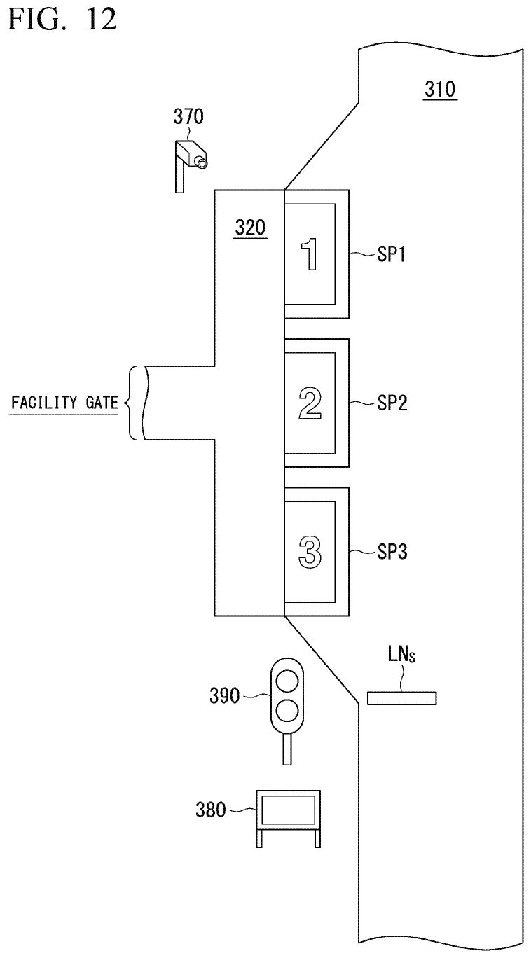

Hereinafter, control for causing a vehicle to stop in the stopping area 310 will be described with reference to examples of some scenes. FIG. 12 is a diagram of the stopping area 310 and the getting-into/out area 320 as viewed from above. A stop line LNs is drawn in the stopping area 310 and an electric bulletin board 380 and a traffic light 390 are installed near the stop line LNs. The electric bulletin board 380 and the traffic light 390 are controlled by the parking lot management device 400. In the stopping area 310, as described above, a first space SP1, a second space SP2, and a third space SP3 are provided. The number of spaces is not limited to three, and may be one, two, or four or more. Parking slots that explicitly partition the spaces need not necessarily be drawn.

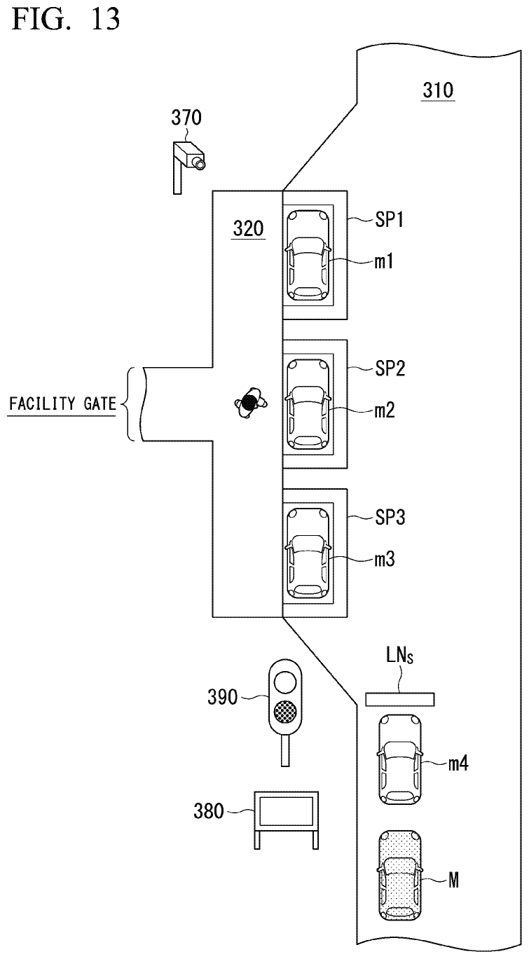

FIG. 13 is a diagram showing an example of a scene in which the host vehicle M arrives at the stopping area 310. In the scene shown in the example of FIG. 13, the vehicle is stopped in any space and a vehicle m4 is already waiting for a space to be empty before the temporary stop line LNs when the host vehicle M carrying a specific user has arrived at the stopping area 310. That is, the scene shown in FIG. 13 shows that the host vehicle M carrying the specific user has passed through the entrance gate 300-in without a reservation. Thus, the vehicle m4 is a vehicle that has been moved from the parking lot PA by automated driving in response to a remote instruction from the parking lot management device 400 or a vehicle that has been manually driven by the occupant and has passed through the entrance gate 300-in.

Because the vehicle is stopped in any space, the controller 420 of the parking lot management device 400 causes the traffic light 390 to be turned on in red or the like indicating the prohibition of entry and causes the electric bulletin board 380 to display information for prompting a user of a vehicle, which cannot stop in any space, to stop before the temporary stop line LNs.

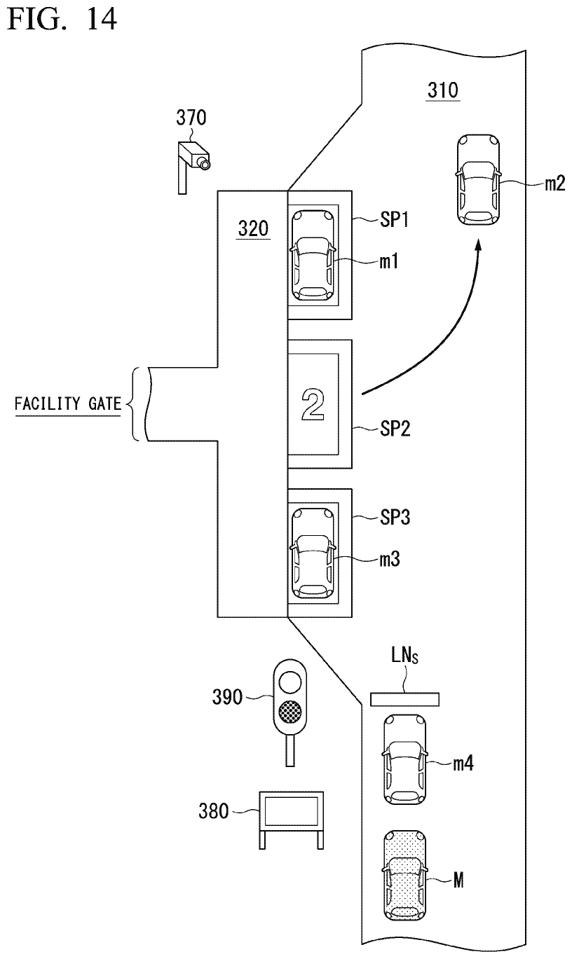

FIG. 14 is a diagram showing another example of a scene in which the host vehicle M has arrived at the stopping area 310. The scene shown in FIG. 14 indicates that the vehicle m2 moves from the second space SP2 and the second space SP2 is empty with respect to the scene shown in FIG. 13. In such a scene, the vehicle m4 is likely to move to the second space SP2 and stop in the second space SP2.

For example, when the second space SP2 is the priority space of the host vehicle M, the controller 420 performs control for prompting a user of the vehicle m4 arriving at the stopping area 310 ahead of the host vehicle M to give up the second space SP2 that is the priority space. Specifically, the controller 420 causes the traffic light 390 to be continuously turned on in red so that the vehicle m4 does not move to the second space SP2 and causes the electric bulletin board 380 to display information indicating that the second space SP2 is the priority space of a subsequent vehicle.

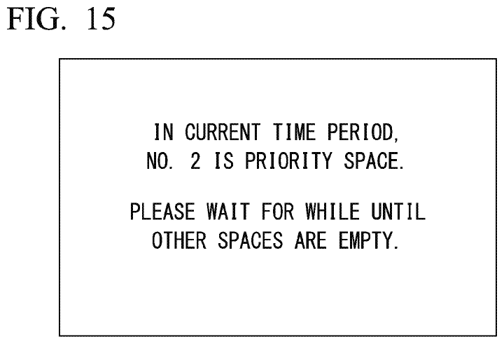

FIG. 15 is a diagram showing an example of information displayed on the electric bulletin board 380. As in the example shown in FIG. 15, information indicating that the second space SP2 is a priority space in a current time period and information for prompting a user to wait at the temporary stop line LNs until another space is empty are displayed as text or an image on the electric bulletin board 380.

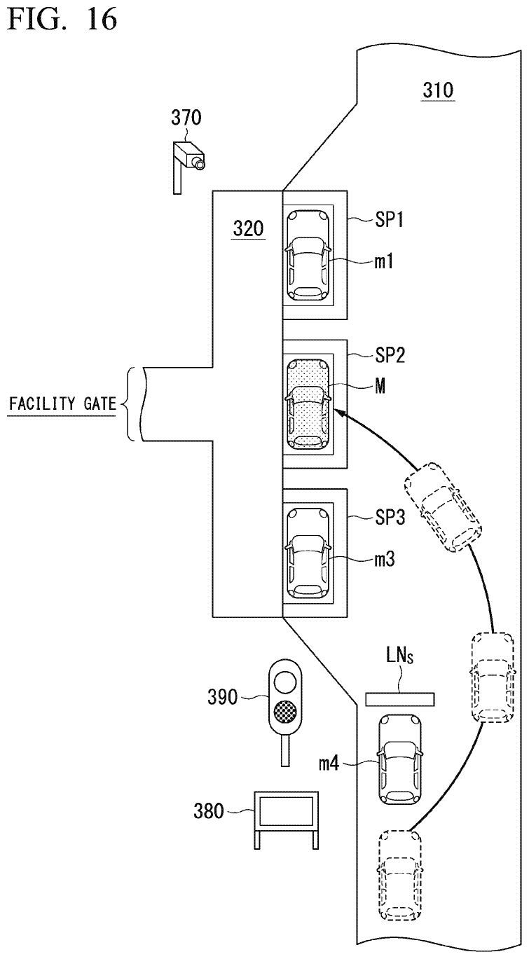

FIG. 16 is a diagram showing another example of a scene in which the host vehicle M has arrived at the stopping area 310. In the scene shown in the example of FIG. 16, the vehicle m4 does not move to the second space SP2 and waits in front of the temporary stop line LNs. In this case, the controller 420 transmits empty space information to the host vehicle M via the communicator 410 and further determines that an incentive is to be provided to the user of the vehicle m4. The action plan generator 140 of the host vehicle M that has received the empty space information generates a target trajectory for causing the host vehicle M to move from a position following the vehicle m4 to the second space SP2. Thereby, the host vehicle M can stop in the second space SP2 that is the priority space.

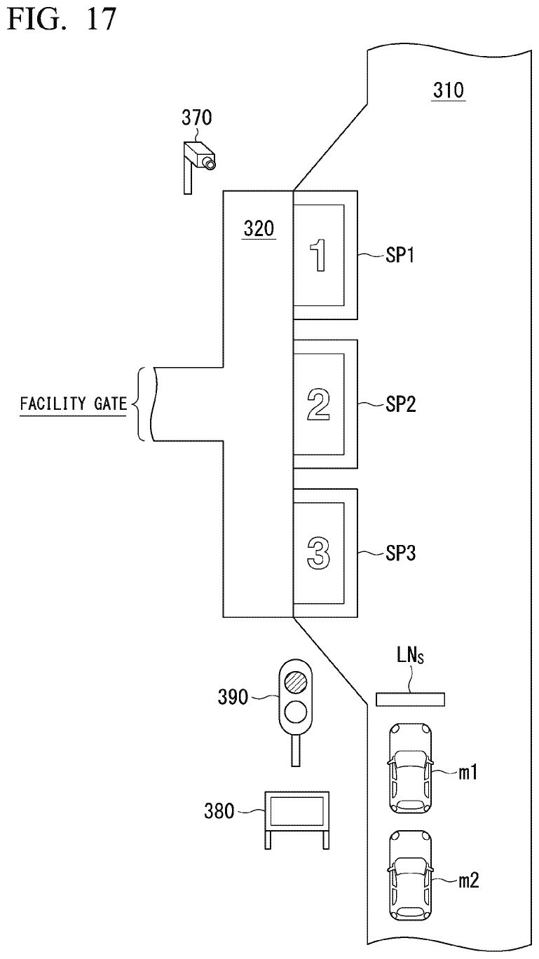

FIG. 17 is a diagram showing an example of a scene in which the host vehicle M has not yet arrived at the stopping area 310. In the scene shown in FIG. 17, vehicles have not stopped in any spaces and vehicles m1 and m2 have arrived at the stopping area 310. In this scene, for example, if a specific user has reserved the use of a facility, there is not a priority space among the three spaces at the current time but there may be a space that changes to a priority space at a reservation time when the specific user will use the facility. Hereinafter, as an example, the description will be given under the assumption that a space that changes to the priority space at a certain time in the not-so-distant future (within a predetermined time period from the current time) is the second space SP2.

When the facility use by the specific user has been reserved in advance, the vehicles m1 and m2 are vehicles that have moved according to automated driving from the parking lot PA in response to a remote instruction from the parking lot management device 400. That is, the number of vehicles is limited. Even if the number of vehicles going from the parking lot PA to the stopping area 310 is limited, a new vehicle may enter the stopping area 310 through the entrance gate 300-in.

The controller 420 of the parking lot management device 400 performs control for prompting users of the vehicles m1 and m2 to give up the second space SP2 that is the priority space in consideration of the presence of a vehicle that has newly entered the stopping area 310 through the entrance gate 300-in in addition to the vehicle that has gone from the parking lot PA to the stopping area 310.

Specifically, the controller 420 causes the traffic light 390 to be turned on in green or the like indicating the permission of entry because there is a space where a vehicle can be stopped and causes the electric bulletin board 380 to display information for prompting a user not to stop his or her vehicle in the second space SP2 because the second space SP2 will change to a priority space at a certain time in the future.

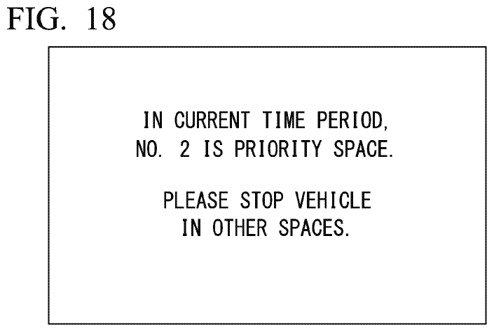

FIG. 18 is a diagram showing another example of information displayed on the electric bulletin board 380. As in the example shown in FIG. 18, information indicating that the second space SP2 is the priority space and information for prompting a user to stop his or her vehicle in another space are displayed as text or an image on the electric bulletin board 380 in the current time period.

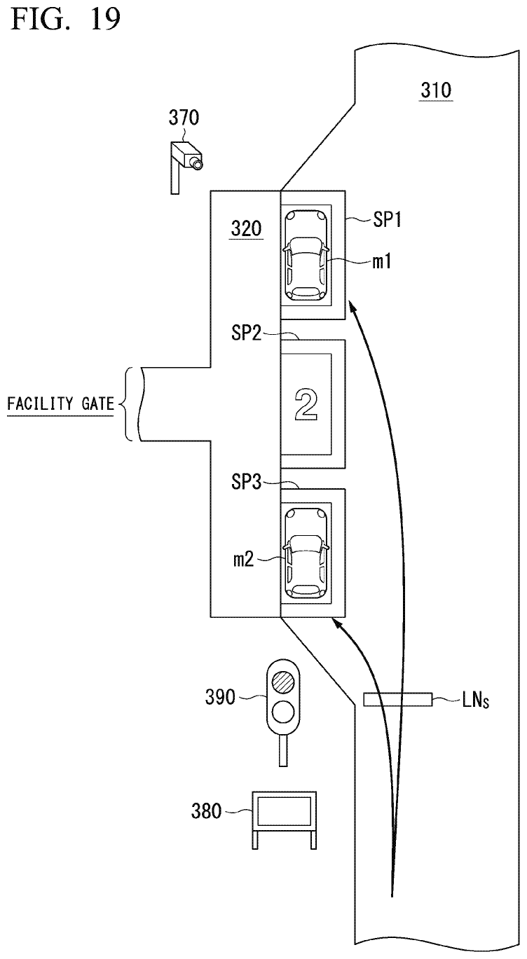

FIG. 19 is a diagram showing another example of a scene in which the host vehicle M has not yet arrived at the stopping area 310. In the scene shown in the example of FIG. 19, the vehicle m1 stops in the first space SP1 and the vehicle m2 stops in the third space SP3 with respect to the scene of the example shown in FIG. 17. In this case, the controller 420 transmits empty space information to the host vehicle M via the communicator 410. At this time, when there is a newly entering vehicle passing through the entrance gate 300-in in the vehicles m1 and m2, the controller 420 determines that an incentive is to be provided to a user of the vehicle.

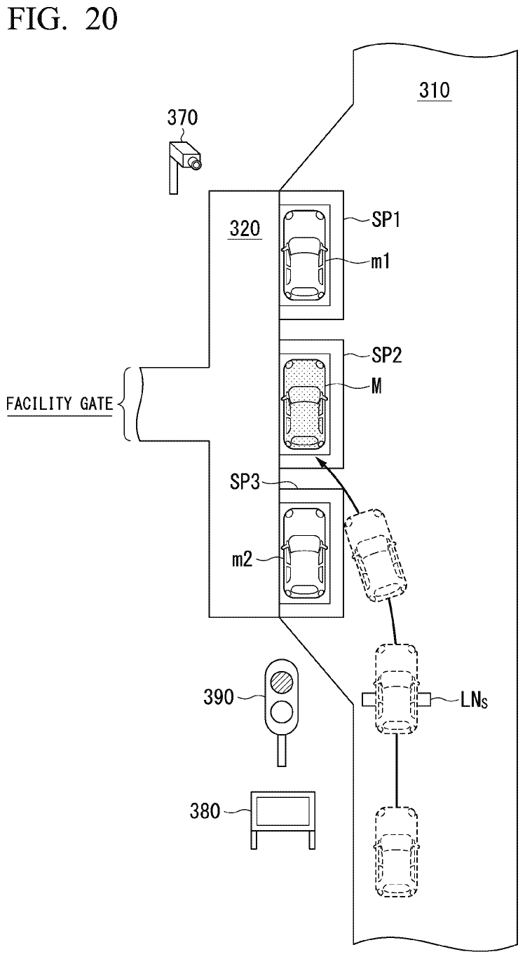

FIG. 20 is a diagram showing another example of a scene in which the host vehicle M has arrived at the stopping area 310. In the example shown in FIG. 20, when the host vehicle M has arrived at the stopping area 310, the second space SP2, which is the priority space, is empty. Thus, the action plan generator 140 generates a target trajectory for causing the host vehicle M to move to the second space SP2. Thereby, the host vehicle M can stop in the second space SP2 that is the priority space.

In the description of the above-described embodiment, the control of the automated driving control device 100 in a scene in which the host vehicle M carrying a specific user has passed through the entrance gate 300-in and has arrived at the stopping area 310 (i.e., a scene at the time of entering) has been described. Hereinafter, the control of the automated driving control device 100 in a scene in which the parking lot management device 400 receives a pick-up request and causes the host vehicle M to move from the parking lot PA to the stopping area 310 after the specific user is allowed to get out of the host vehicle M in the getting-into/out area 320 and parks the host vehicle M in the parking lot PA (i.e., a scene at the time of leaving) will be described.

### [Process Flow of Automated Driving Control Device at Time of Leaving]

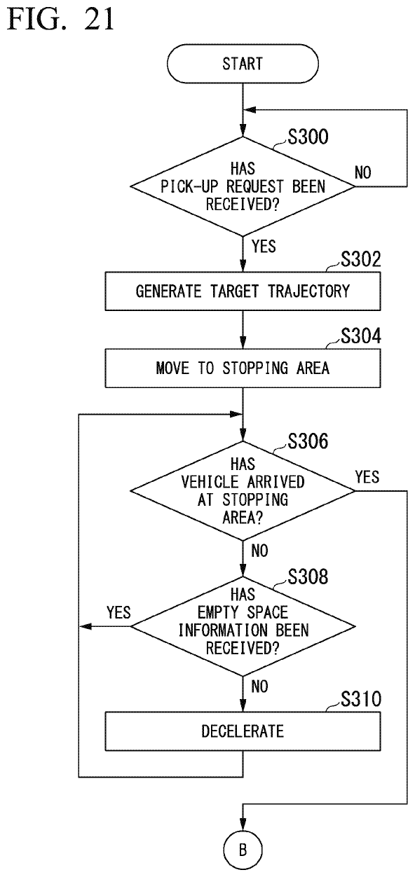

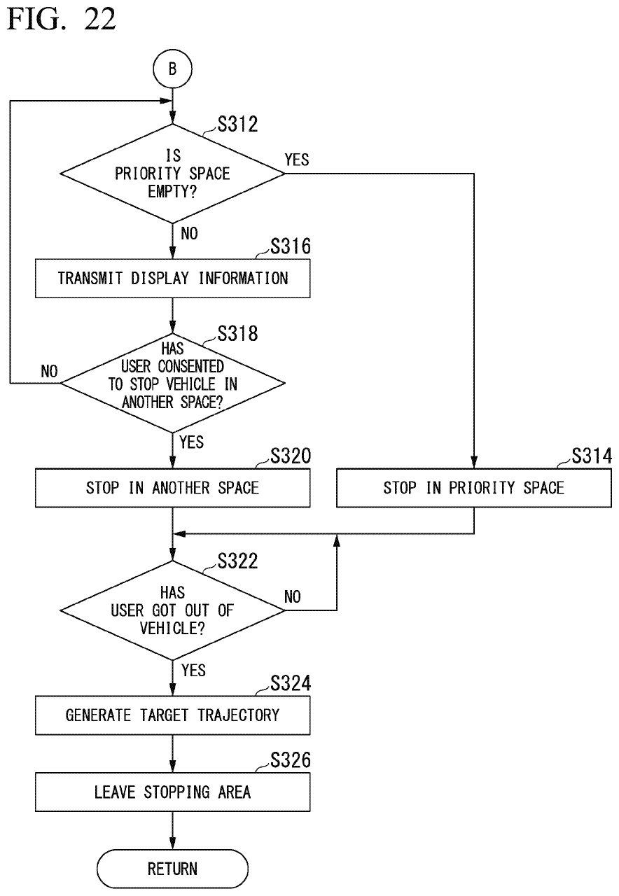

Hereinafter, a series of processing steps of the automated driving control device 100 at the time of leaving will be described with reference to flowcharts. FIGS. 21 and 22 are flowcharts showing another example of the series of processing steps of the automated driving control device 100 according to the embodiment. The process of the present flowchart is iteratively performed at predetermined time intervals when a specific user is not in the host vehicle M. While the process of the present flowchart is performed, the recognizer 130 is assumed to continuously perform various types of recognition unless otherwise specified.

First, the action plan generator 140 waits until the communication device 20 receives a pick-up request from the parking lot management device 400 (step S300), determines an autonomous parking event as an event of a route leading to the stopping area 310 when the communication device 20 has received the pick-up request from the parking lot management device 400, and starts the autonomous parking event. Then, the action plan generator 140 generates a target trajectory for causing the host vehicle M to move from the parking lot PA to the stopping area 310 (step S302).

Next, the second controller 160 performs automated driving on the basis of the target trajectory generated by the action plan generator 140 and causes the host vehicle M to move to the stopping area 310 (step S304).

Next, the action plan generator 140 determines whether or not the host vehicle M has arrived at the stopping area 310 with reference to a recognition result of the recognizer 130 (step S306).

When it is determined that the host vehicle M has not yet arrived at the stopping area 310, the action plan generator 140 determines whether or not the communication device 20 has received empty space information in the stopping area 310 (step S308).

The action plan generator 140 maintains a current vehicle speed without changing the speed or acceleration, which is the speed element of the target trajectory, when the empty space information has been received by the communication device 20 but the host vehicle M has not yet arrived at the stopping area 310.

When the empty space information has not been received by the communication device 20 and the host vehicle M has not yet arrived at the stopping area 310, the action plan generator 140 reduces the speed or the acceleration that is the speed element of the target trajectory in accordance with a state in which the host vehicle M approaches the stopping area 310 so that the host vehicle M is gradually decelerated (step S310).

When it is determined that the host vehicle M has arrived at the stopping area 310, the action plan generator 140 determines whether or not the priority space within the stopping area 310 is empty on the basis of a recognition result of the recognizer 130 (step S312).

When no other vehicles are stopped in the priority space and the priority space is empty, the action plan generator 140 generates a target trajectory for causing the host vehicle M to move to the priority space and stop in the priority space. In response to this, the second controller 160 causes the host vehicle M to stop in the priority space by controlling the speed and steering of the host vehicle M on the basis of the target trajectory (step S314).

When another vehicle is already stopped in the priority space and the priority space is not empty, the communication controller 182 transmits information for causing a terminal device (for example, a portable phone) carried by a specific user or a person related to the specific user to display a consent confirmation screen (hereinafter referred to as display information) via the communication device 20 (step S316).

The consent confirmation screen is displayed on the terminal device that has received the display information. For example, when a consent operation is input on the consent confirmation screen, the terminal device transmits a signal indicating the consent operation to the host vehicle M.

The action plan generator 140 determines whether or not the specific user or the person related to the specific user has consented to stop the host vehicle M in another space in accordance with whether or not the signal indicating the consent operation has been received by the communication device 20 (step S318). For example, the action plan generator 140 determines that the user has consented to stop the host vehicle M in another space when the communication device 20 has received the signal indicating the consent operation and determines that the user has not consented to stop the host vehicle M in another space when the communication device 20 has not received the signal indicating the consent operation until a predetermined time period has elapsed from the transmission of the display information.

When it is determined that the specific user or the person related to the specific user has not consented to stop the host vehicle M in another space, the action plan generator 140 causes the host vehicle M to wait at a place until the priority space is empty.

When it is determined that the specific user or the person related to the specific user has consented to stop the host vehicle M in another space, the action plan generator 140 generates a target trajectory for causing the host vehicle M to move to another space and stop in the other space. In response to this, the second controller 160 causes the host vehicle M to stop in the other space by controlling the speed and the steering of the host vehicle M on the basis of the target trajectory (step S320).

When the buttons B6 to B8 have been operated on the space selection page shown in the example of FIG. 8, i.e., when the user consents to set another space as a stop position in preparation for a case in which the priority space is not already empty, the processing of S316 and S318 may be omitted.

Regardless of the operation on the selection page, the processing of S316 and S318 may be omitted. In this case, the action plan generator 140 causes the host vehicle M to wait at a place until the priority space is empty as in the case when it is determined that the specific user or the person related to the specific user has not consented to stop the host vehicle M in another space.

Next, the action plan generator 140 determines whether or not a specific user has got into the host vehicle M (step S322). For example, the action plan generator 140 may determine whether or not a specific user has got into the host vehicle M on the basis of a detection result of the door sensor that detects opening and closing of a door of the host vehicle M and an image of the camera installed in the host vehicle M.

When the specific user has got into the host vehicle M, the action plan generator 140 generates a target trajectory from the stopping area 310 to the exit gate 300-out (step S324). In response to this, the second controller 160 causes the host vehicle M to pass through the exit gate 300-out and move to the road Rd in accordance with the target trajectory (step S326). Thus, the process of the present flowchart ends.

According to the embodiment described above, the automated driving control device 100 recognizes a surrounding situation of the host vehicle M, generates a target trajectory on the basis of a recognition result, and causes the host vehicle M to stop in the stopping area 310 facing the getting-into/out area 320 connected to a gate of the destination facility to be visited by controlling at least one of the steering and speed of the host vehicle M on the basis of the generated target trajectory. When the host vehicle M is used by a specific user, the parking lot management device 400 limits the number of other vehicles to be moved from the parking lot PA to the stopping area 310 or prompts a user of another vehicle, which has already started to move to the stopping area 310, to give up a priority space for the host vehicle M. Thereby, when the specific user gets out of the host vehicle M in the getting-into/out area 320 or gets into the host vehicle M in the getting-into/out area 320, the automated driving control device 100 can cause the host vehicle M to stop in the priority space among a plurality of spaces of the stopping area 310 in preference to other vehicles. As a result, consideration can be given to the use of a parking lot by a specific user even though a dedicated space with an international symbol mark or the like is not provided.

### [Hardware Configuration]

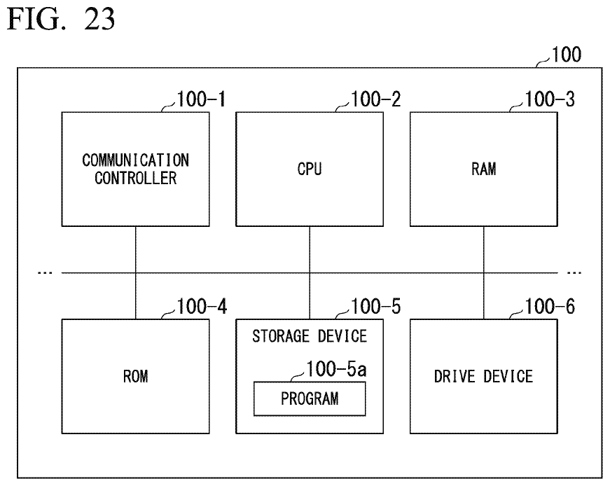

FIG. 23 is a diagram showing an example of a hardware configuration of the automated driving control device 100 according to the embodiment. As shown in FIG. 23, the automated driving control device 100 has a configuration in which a communication controller 100-1, a CPU 100-2, a RAM 100-3 used as a working memory, a ROM 100-4 storing a boot program and the like, a storage device 100-5 such as a flash memory or a HDD, a drive device 100-6, and the like are mutually connected by an internal bus or a dedicated communication line. The communication controller 100-1 communicates with components other than the automated driving control device 100. The storage device 100-5 stores a program 100-5a to be executed by the CPU 100-2. This program is loaded into the RAM 100-3 by a direct memory access (DMA) controller (not shown) or the like and executed by the CPU 100-2. Thereby, some or all of the first controller 120, the second controller 160, and the third controller 180 are implemented.

The embodiment described above can be represented as follows.

A vehicle control system, including:

at least one memory storing a program; and

at least one processor,

wherein the processor executes the program to:

recognize a surrounding situation of a first vehicle;

cause the first vehicle to stop in a predetermined area of a parking lot by controlling at least one of steering and a speed of the first vehicle on the basis of the recognized situation; and

when a specific user having priority over another user to get into or out of the first vehicle uses the first vehicle, cause the first vehicle to stop at a priority position closer to a pedestrian gate leading to an outside of the parking lot than other positions within the area in preference to a second vehicle different from the first vehicle.

Although modes for carrying out the present invention have been described using embodiments, the present invention is not limited to the embodiments, and various modifications and substitutions can also be made without departing from the scope and spirit of the present invention.

What is claimed is:

1. A vehicle control system, comprising:
a recognizer configured to recognize a surrounding situation of a first vehicle; and
a driving controller configured to cause the first vehicle to stop in a predetermined area of a parking lot by controlling at least one of steering and a speed of the first vehicle on the basis of the situation recognized by the recognizer,
wherein, when a specific user having priority over another user to get into or out of the first vehicle uses the first vehicle, the driving controller causes the first vehicle to stop at a priority position closer to a pedestrian gate leading to an outside of the parking lot than other positions within the area in preference to a second vehicle different from the first vehicle.

2. The vehicle control system according to claim 1, further comprising an inputter configured to receive an input operation of the user,
wherein, when a first operation of making a reservation for stopping the first vehicle used by the specific user at the priority position is input to the inputter, the driving controller causes the first vehicle to stop at the priority position in preference to the second vehicle.

3. The vehicle control system according to claim 2, wherein, when a second operation of selecting at least one of a plurality of positions leading to the gate as the priority position has been input to the inputter, the driving controller causes the first vehicle to stop at the position selected as the priority position in preference to the second vehicle.

4. The vehicle control system according to claim 2, further comprising a management device configured to cause the second vehicle to be restricted from stopping at the priority position on the basis of a scheduled time at which the first vehicle stops at the priority position when the first operation has been input to the inputter.

5. The vehicle control system according to claim 2, further comprising a management device configured to cause the second vehicle to be restricted from stopping at the priority position on the basis of a relative positional relationship between the priority position and a position of the first vehicle when the first operation has been input to the inputter.

6. The vehicle control system according to claim 2, further comprising a management device configured to limit the number of second vehicles that enter the area including the priority position on the basis of a scheduled time at which the first vehicle stops at the priority position when the first operation has been input to the inputter.

7. The vehicle control system according to claim 4, further comprising:
a first communication device mounted in the first vehicle and configured to communicate with a second communication device outside the vehicle; and
a communication controller configured to transmit first information indicating that a user using the first vehicle is the specific user to the second communication device via the first communication device when the first vehicle enters the area,
wherein the management device restricts the second vehicle from being stopped at the priority position in preference to the first vehicle when the first information has been received by the second communication device.

8. The vehicle control system according to claim 2, further comprising a management device configured to determine that an incentive is to be provided to a user of the second vehicle that has not stopped at the priority position.

9. The vehicle control system according to claim 1, wherein the driving controller changes the speed of the first vehicle when the first vehicle is moved to the priority position.

10. The vehicle control system according to claim 9, wherein the driving controller reduces the speed of the first vehicle when the second vehicle is present at the priority position as compared with when the second vehicle is not present at the priority position.

11. A vehicle control method, comprising:
recognizing, by a computer mounted in a first vehicle, a surrounding situation of the first vehicle;
causing, by the computer, the first vehicle to stop in a predetermined area of a parking lot by controlling at least one of steering and a speed of the first vehicle on the basis of the recognized situation; and
when a specific user having priority over another user to get into or out of the first vehicle uses the first vehicle, causing, by the computer, the first vehicle to stop at a priority position closer to a pedestrian gate leading to an outside of the parking lot than other positions within the area in preference to a second vehicle different from the first vehicle.

12. A computer-readable non-transitory storage medium storing a program for causing a computer mounted in a first vehicle to:
recognize a surrounding situation of the first vehicle;
cause the first vehicle to stop in a predetermined area of a parking lot by controlling at least one of steering and a speed of the first vehicle on the basis of the recognized situation; and
when a specific user having priority over another user to get into or out of the first vehicle uses the first vehicle, cause the first vehicle to stop at a priority position closer to a pedestrian gate leading to an outside of the parking lot than other positions within the area in preference to a second vehicle different from the first vehicle.
